(19) United States
(12) Patent Application Publication
(10) Pub. No.: US 2020/0036204 A1
(43) Pub. Date: Jan. 30, 2020

(54) Battery-Charger Reminder System

(71) Applicant: Terry Gibbs, Williamston, NC (US)

(72) Inventor: Terry Gibbs, Williamston, NC (US)

(21) Appl. No.: 16/047,670

(22) Filed: Jul. 27, 2018

(51) Int. Cl. H02J 7/00; H02J 7/02; H04B 1/3883

(52) U.S. Cl. CPC H02J 7/0047; H02J 7/0042; H02J 2007/0096; H04B 1/3883; H02J 7/025

(57) ABSTRACT

Some examples of the present disclosure are related to a battery-charger reminder system. One example can include a battery charger with a wireless interface configured to transmit a wireless signal. The wireless signal can be used by a mobile device to determine a proximity of the battery charger to the mobile device. Another example can include a mobile device configured determine whether a distance between a battery charger and the mobile device exceeds a predefined threshold based on a wireless signal from the battery charger. If the mobile device determines that the distance exceeds the predefined threshold, the mobile device can generate a notification associated with the battery charger (e.g., to remind a user not to forget the battery charger).

### TECHNICAL FIELD

The present disclosure relates generally to battery chargers and battery charger structures. More specifically, but not by way of limitation, the present disclosure relates to a battery-charger reminder system.

### BACKGROUND

Mobile devices rely on batteries to provide the electrical power required for operation. Over time, these batteries deplete and need to be recharged using a battery charger. But users often accidentally forget their battery chargers at home or other locations, rendering them unable to recharge their mobile devices.

### SUMMARY

One example of the present disclosure can include a battery charger for a mobile device. The battery charger includes a wireless interface configured to transmit a wireless signal usable by the mobile device to determine a proximity of the battery charger to the mobile device.

In some examples, the battery charger may include an attachment device configured to electrically couple the battery charger to a power source for receiving an electrical signal. The battery charger may include a coupling device configured to electrically couple the battery charger to the mobile device for charging a battery of the mobile device. The battery charger may include electrical circuitry that is electrically coupled between the attachment device and the coupling device, the electrical circuitry being configured to convert the electrical signal from the power source into a modified version of the electrical signal. The wireless interface can be electrically coupled to the electrical circuitry for receiving the modified version of the electrical signal.

In some examples, the electrical circuitry may include a step-down transformer configured to transform the electrical signal into the modified version of the electrical signal, the modified version of the electrical signal having a lower voltage than the electrical signal. The wireless interface can be configured to operate using the lower voltage provided by the modified version of the electrical signal.

In some examples, the battery charger may include a sensor. The battery charger can detect that the battery charger is not coupled to the mobile device based on a sensor signal from the sensor. The battery charger can cause the wireless interface to transmit the wireless signal in response to detecting that the battery charger is not coupled to the mobile device.

In some examples, the battery charger may be configured to create an electromagnetic coupling with the mobile device for wirelessly charging a battery of the mobile device.

In some examples, the battery charger may include a global positioning system (GPS) unit configured to identify a GPS location of the battery charger. The wireless signal can indicate the GPS location of the battery charger.

Another example of the present disclosure can include a mobile device. The mobile device includes a battery, a wireless interface configured to transmit and receive wireless signals; a processing device; and a memory device. The memory device includes program code that is executable by the processing device for causing the processing device to perform operations. For example, the program code can cause the processing device to receive a wireless signal from a battery charger via the wireless interface. The program code can cause the processing device to determine that a distance between the battery charger and the mobile device exceeds a predefined distance threshold based on the wireless signal. The program code can cause the processing device to, in response to determining that the distance exceeds the predefined distance threshold, generate a notification associated with the battery charger.

In some examples, the wireless signal may indicate a first global positioning system (GPS) location of the battery charger, and the mobile device may include a GPS unit for determining a second GPS location of the mobile device. The memory device may further include program code that is executable by the processing device for causing the processing device to determine the distance between the battery charger and the mobile device by comparing the first GPS location of the battery charger to the second GPS location of the mobile device.

In some examples, the memory device may further include program code that is executable by the processing device for causing the processing device to determine a signal strength of the wireless signal, and determine that the distance between the battery charger and the mobile device exceeds the predefined distance threshold based on the signal strength of the wireless signal being below a signal-strength threshold.

In some examples, the wireless signal may be a Bluetooth signal and the wireless interface may comprise a Bluetooth interface. In some examples, the mobile device may include a mobile phone, a tablet, an e-reader, or a laptop computer.

In some examples, the notification may comprise at least one of: (i) a visual notification configured to be output by a display, (ii) an auditory notification configured to be output by an audio output device, or (iii) a haptic notification configured to be output by a haptic output device. The notification may be configured to remind a user about the battery charger.

In some examples, the memory device may further include program code that is executable by the processing device for causing the processing device to use the wireless interface to wirelessly transmit a request signal. The program code can cause the processing device to wait for a response to the request signal from the battery charger for a predefined time period. The program code can cause the processing device to determine that the response to the request signal was not received from the battery charger within the predefined time period. The program code can cause the processing device to, in response to determining that the response was not received from the battery charger within the predefined time period, generate the notification associated with the battery charger.

In some examples, the mobile device is part of a system that includes the battery charger. The battery charger can include an attachment device configured to couple the battery charger to a power source for receiving an electrical signal. The battery charger can include a coupling device configured to couple the battery charger to the mobile device for charging the battery of the mobile device. The battery charger can include electrical circuitry that is coupled between the attachment device and the coupling device, the electrical circuitry being configured to convert the electrical signal from the power source into a modified version of the electrical signal. The battery charger can include a wireless interface coupled to the electrical circuitry for receiving the modified version of the electrical signal, the wireless interface being configured to transmit the wireless signal to the mobile device.

Yet another example of the present disclosure can include a method. The method can include receiving a wireless signal from a battery charger, wherein the battery charger is separate from a mobile device and operable to charge a battery of the mobile device. The method can include determining that a distance between the battery charger and the mobile device exceeds a predefined distance threshold based on the wireless signal. The method can include, in response to determining that the distance exceeds the predefined distance threshold, generating a notification associated with the battery charger. Some or all of the method steps can be implemented by the mobile device.

In some examples, the wireless signal indicates a first global positioning system (GPS) location of the battery charger. The method can include determining a second GPS location of the mobile device using a GPS unit coupled to the mobile device. The method can include determining the distance between the battery charger and the mobile device by comparing the first GPS location of the battery charger to the second GPS location.

In some examples, the method can include determining a signal strength of the wireless signal. The method can include determining that the distance between the battery charger and the mobile device exceeds the predefined distance threshold based on the signal strength of the wireless signal being below a signal-strength threshold.

In some examples, the method can include transmitting, by the battery charger, the wireless signal to the mobile device.

These illustrative embodiments are mentioned not to limit or define the limits of the present subject matter, but to provide examples to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1 shows an example of a battery-charger reminder system in which a mobile device is coupled to a battery charger for charging the mobile device's battery.

FIG. 2 shows an example of the battery-charger reminder system of FIG. 1 in which the mobile device is decoupled from the battery charger.

FIG. 3 shows another example of a battery-charger reminder system in which a mobile device is positioned on a battery charger for charging the mobile device's battery.

FIG. 4 shows an example of the battery-charger reminder system of FIG. 3 in which the mobile device remote from the battery charger.

FIG. 5 shows a block diagram of an example of a battery charger.

FIG. 6 shows an example of a flow chart of steps for implementing a battery-charger reminder system.

FIG. 7 shows a block diagram of an example of a mobile device.

FIG. 8 shows another example of a flow chart of steps for implementing a battery-charger reminder system.

### DETAILED DESCRIPTION

The following description recites various aspects and embodiments of the present invention. No particular embodiment is intended to define the scope of the invention. Rather, the embodiments merely provide non-limiting examples of various methods, systems, and apparatuses that are at least included within the scope of the invention. The description is to be read from the perspective of one of ordinary skill in the art; therefore, information well-known to the skilled artisan may not necessarily be included.

### Definitions and Abbreviations

The following terms, unless otherwise indicated, shall be understood to have the following meanings:

The terms “a,” “an,” and “the” can refer to one or more unless specifically noted otherwise.

The term “or” is not to be construed as identifying mutually exclusive options. For example, the phrase “X contains A or B” can mean that X contains A and not B, X contains B and not A, or X contains both A and B. That is, the term “or” is used to mean “and/or” unless explicitly indicated to refer to alternatives only or the alternatives are mutually exclusive, although the disclosure may support a definition that refers to only alternatives and “and/or.” As used herein “another” can mean at least a second or more.

The term “mechanical coupling” can refer to a direct or indirect physical connection between two or more objects. A mechanical coupling between objects may or may not include an electrical coupling between the objects.

The term “electrical coupling” can refer to a channel between two or more objects through which electrical energy can be transferred. The channel between the objects can be wired or wireless (e.g., an electromagnetic coupling for wireless power transfer). An electrical coupling between objects may or may not include a mechanical coupling between the objects.

The term “coupling” can refer to a mechanical coupling, electrical coupling, or both.

### Illustrative Examples of a Battery-Charger Reminder System

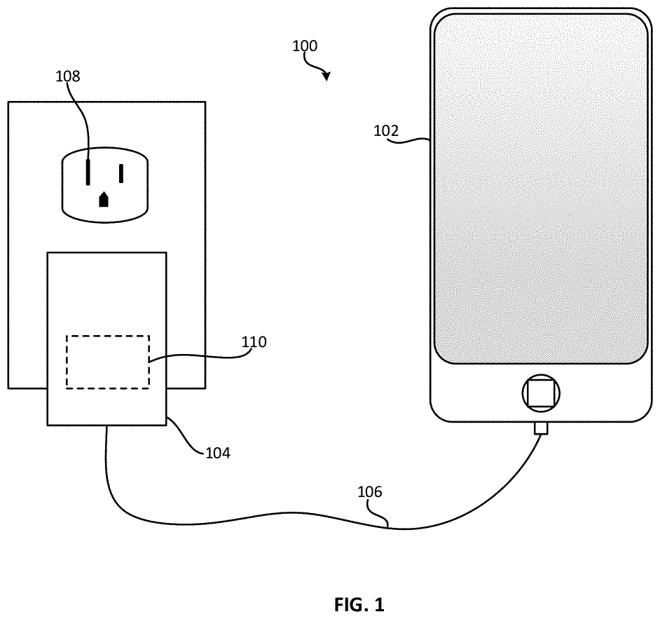

FIG. 1 shows an example of a battery-charger reminder system 100 in which a mobile device 102 is coupled to a battery charger 104 for charging the mobile device's battery. In this example, the mobile device 102 is a mobile phone. But, in other examples, the mobile device 102 can include a tablet, e-reader, laptop computer, portable gaming device, music player, or wearable device (e.g., a watch, headset, glasses, or bracelet).

The mobile device 102 is coupled to the battery charger 104 via a cable 106, such as a Universal Serial Bus (USB) cable. And the battery charger 104 is coupled to a power source 108 (e.g., an outlet in a wall or power strip), from which the battery charger 104 obtains the electrical power for charging the mobile device 102.

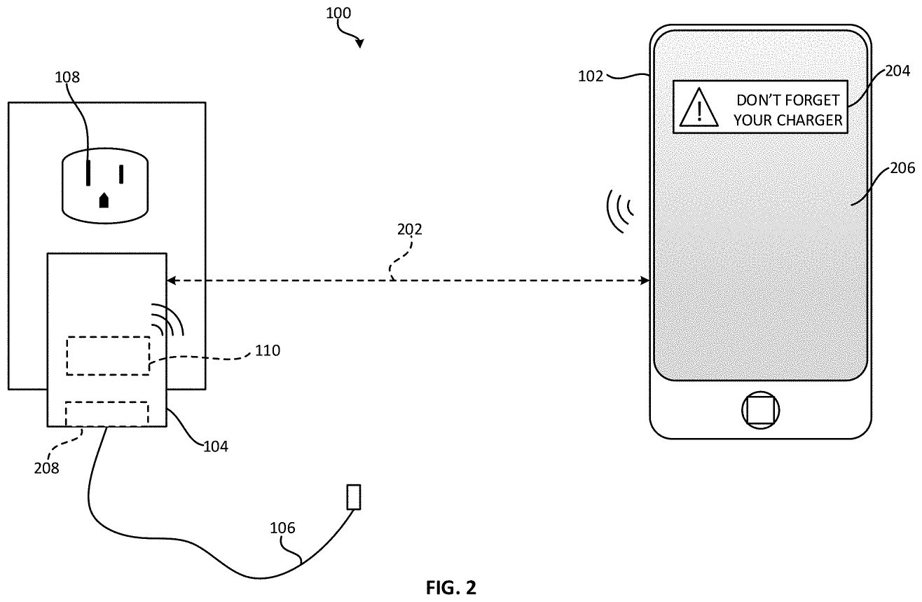

In one particular example, the battery charger 104 is plugged into a wall outlet in the user's house. Once the mobile device's battery is adequately charged, a user may decouple the mobile device 102 from the battery charger 104, while leaving the battery charger 104 plugged into the wall outlet. The user may then put the mobile device 102 in her purse or pocket and perform various activities around her house. At some point in the future, the user may go to leave the house. To prevent the user from forgetting the battery charger 104, the battery charger 104 can transmit wireless signals to the mobile device 102 via a wireless interface 110. The mobile device 102 can use the wireless signals to trigger a reminder about the battery charger 104, for example, as shown in FIG. 2.

In FIG. 2, the battery charger 104 includes a sensor 208 configured to detect whether the mobile device 102 is electrically coupled to the battery charger 104. Examples of the sensor 208 can include a current sensor, voltage sensor, or Hall Effect sensor. If the battery charger 104 determines that it is not electrically coupled to the mobile device 102, the battery charger 104 can initiate a process for transmitting one or more wireless signals via the wireless interface 110. The mobile device 102 can receive the wireless signal(s) from the battery charger 104 and determine, based on the wireless signal(s), whether a distance 202 between the battery charger 104 and the mobile device 102 exceeds a predefined distance threshold. One example of the predefined distance threshold can be 8 meters (m), but the predefined distance threshold can be customizable and set by the user of the mobile device 102. If the distance 202 exceeds the predefined distance threshold, the mobile device 102 can generate a notification 204 to remind the user about the battery charger 104.

In the example shown in FIG. 2, the notification 204 is a visual notification output on a display 206. But, in other examples, the notification can include an auditory notification produced by an audio output device, a haptic notification produced by a haptic output device, or any combination of types of notifications. Auditory notifications and haptic notifications may be useful for reminding the user about the battery charger 104 in situations when the mobile device's display 206 is hidden, for example, when the mobile device 102 is in the user's purse or pocket.

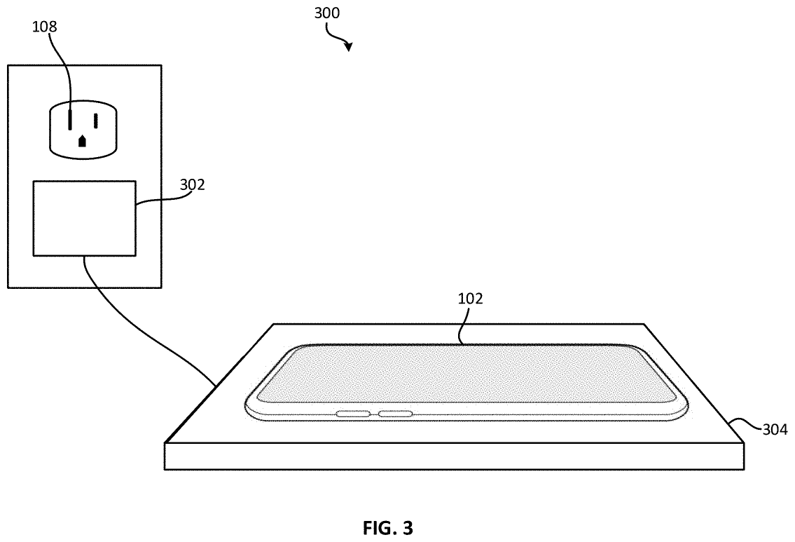

FIG. 3 shows another example of a battery-charger reminder system 300 in which a mobile device 102 is positioned on a battery charger 304 for charging the mobile device's battery. In this example, the battery charger 304 includes a wireless charging-pad. The wireless charging-pad can generate an electromagnetic coupling (e.g., an inductive coupling or capacitive coupling) with the mobile device 102 to wirelessly charge the mobile device 102. The wireless charging-pad is coupled to a power source 108 via an attachment device 302 to obtain the electrical power for charging the mobile device 102.

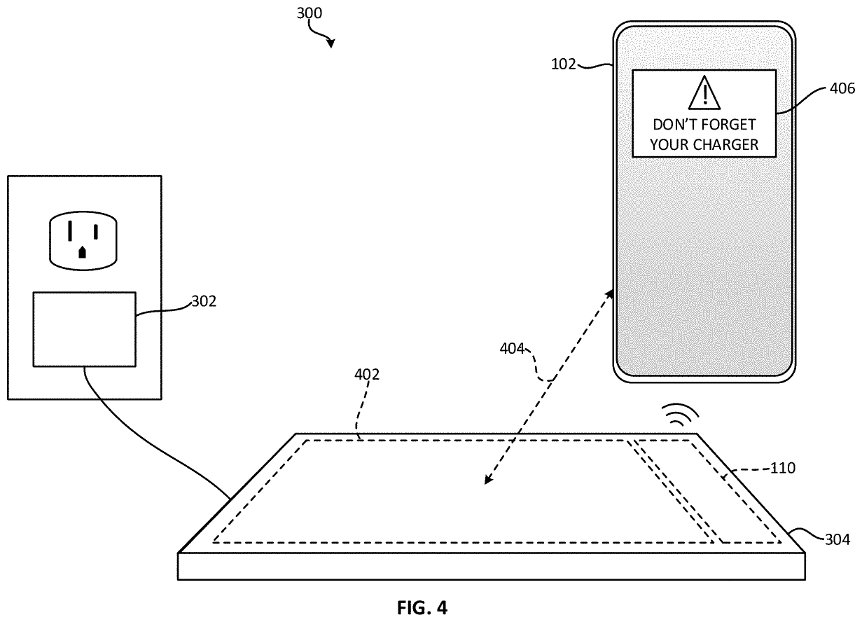

To prevent a user from forgetting the battery charger 304, the battery charger 304 can transmit wireless signals to the mobile device 102 via a wireless interface. For example, the wireless charging-pad can transmit wireless signals to the mobile device 102 via the wireless interface. The mobile device 102 can use the wireless signals to trigger a reminder about the battery charger 304, for example, as shown in FIG. 4.

In FIG. 4, the battery charger 304 includes a sensor 402 configured to detect whether the mobile device 102 is mechanically coupled to the battery charger 304. In one example, the sensor 402 is a force sensor that detects an amount of force applied to the battery charger 304. The battery charger 304 can use the force sensor to determine if the amount of force exceeds a predefined force-threshold. If so, it may indicate that the mobile device 102 is positioned on (and thus mechanically coupled to) the battery charger 304. Alternatively, the battery charger 304 can detect that the amount of force is below the predefined force-threshold, which may indicate that the mobile device 102 is not positioned on (and thus not mechanically coupled to) the battery charger 304. In another example, the sensor 402 is a button that closes or opens an electrical circuit in response to the mobile device 102 being positioned on the battery charger 304, thereby indicating that the mobile device 102 is mechanically coupled to the battery charger 304.

If the battery charger 304 determines that the mobile device 102 is not mechanically coupled to the battery charger 304, the battery charger 304 can initiate a process for transmitting one or more wireless signals via a wireless interface 110 to the mobile device 102. The mobile device 102 can receive the wireless signal(s) from the battery charger 304 and determine a distance 404 between the battery charger 304 and the mobile device 102 based on the wireless signal(s). If the distance 404 exceeds a predefined distance threshold, the mobile device 102 can generate a notification 406 associated with the battery charger 304.

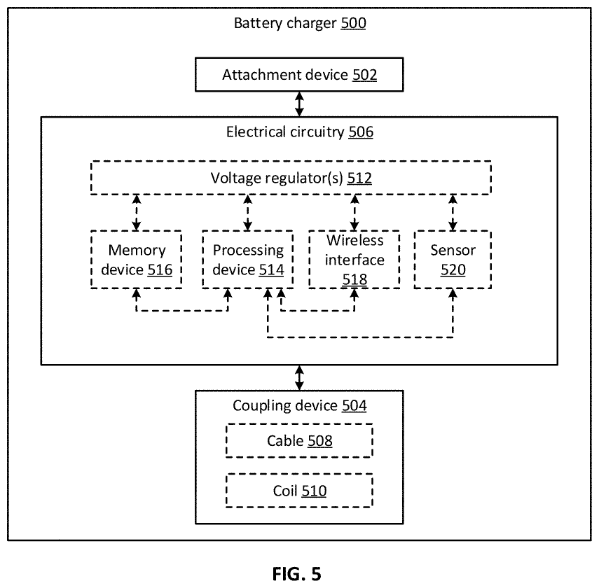

FIG. 5 shows a block diagram of an example of a battery charger 500. The battery charger 500 can include an attachment device 502, a coupling device 504, and electrical circuitry 506 there-between.

The attachment device 502 can couple the battery charger 500 to a power source for obtaining electrical power. In some examples, the attachment device 502 can include a prong, a screw, a clip, a clamp, a bolt, a clasp, or any combination of these. For example, the attachment device 502 can include at least two conductive prongs configured to plug into an electrical outlet.

The coupling device 504 can couple the battery charger 500 to a mobile device for charging the mobile device. In some examples, the coupling device 504 can include a cable 508 configured to connect to a port (e.g., a USB port) of the mobile device for transmitting electrical power to the mobile device. In other examples, the coupling device 504 can include a coil 510 for wirelessly charging the mobile device (e.g., via an electromagnetic coupling).

The electrical circuitry 506 can be coupled between the attachment device 502 and the coupling device 504. The electrical circuitry 506 can include any number and combination of voltage regulators 512 configured to receive an input voltage and provide an output voltage that is different from the input voltage. For example, the voltage regulators 512 can include a voltage regulator (e.g., a step-down transformer) configured to reduce a 120 v electrical signal to 5 v for charging the mobile device. The voltage regulators 512 can also include another voltage regulator configured to reduce the 5 v electrical signal to 3.3 v for powering one or more electrical components of the battery charger 500, such as a processing device 514, memory device 516, wireless interface 518, and/or sensor 520.

The processing device 514 can include one processing device or multiple processing devices. Examples of the processing device 514 include a Field-Programmable Gate Array (FPGA), an application-specific integrated circuit (ASIC), a microprocessor, etc. The processing device 514 can execute one or more operations for implementing a battery-charger reminder system. The processing device 514 can execute instructions stored in the memory device 516 to perform the operations. In some examples, the instructions can include processor-specific instructions generated by a compiler or an interpreter from code written in any suitable computer-programming language, such as C, C++, C#, etc.

The memory device 516 can include one memory device or multiple memory devices. The memory device 516 can be non-volatile and may include any type of memory device that retains stored information when powered off. Non-limiting examples of the memory device 516 include electrically erasable and programmable read-only memory (EEPROM), flash memory, or any other type of non-volatile memory. In some examples, at least some of the memory device can include a medium from which the processing device 514 can read instructions. A computer-readable medium can include electronic, optical, magnetic, or other storage devices capable of providing the processing device 514 with computer-readable instructions or other code. Non-limiting examples of a computer-readable medium include magnetic disk(s), memory chip(s), ROM, random-access memory (RAM), an ASIC, a configured processor, optical storage, or any other medium from which a computer processor can read instructions.

The wireless interface 518 can include one wireless interface or multiple wireless interfaces. The wireless interface 518 can facilitate a network connection or otherwise facilitate wireless communication between electronic devices. Examples of the wireless interface 518 can include an IEEE 802.11 interface, Bluetooth interface, near-field communication (NFC) interface, RFID interface, radio interface for accessing cellular telephone networks (e.g., a transceiver/antenna for accessing a CDMA, GSM, UMTS, or other mobile communications network), or any combination of these.

The sensor 520 can include one sensor or multiple sensors. Examples of the sensor 520 can include a Hall effect sensor, current sensor, voltage sensor, force sensor, button, global positioning system (GPS) unit, gyroscope, depth sensor, range sensor, ultrasonic transducer, a coil, or any combination of these. The sensor 520 can transmit one or more sensor signals to the processing device 514 and/or other parts of the electrical circuitry 506.

The electrical circuitry 506 can additionally or alternatively include other electrical components, such as transistors, resistors, capacitors, inductors, integrated circuit (IC) components, operational amplifiers, tubes, comparators, timing devices, or any combination of these.

In some examples, various electrical components can replace the functions of the processing device 514, memory device 516, sensor 520, or any combination of these. For example, the electrical circuitry 506 can include any suitable combination of electrical components for operating the wireless interface 518, the sensor 520, or both, independent of a processing device 514.

The battery charger 500 shown in FIG. 5 is intended to illustrative, and other examples can include more components, fewer components, different components, or a different configuration of the components shown in FIG. 5. For instance, the battery charger 500 may lack the processing device 514, memory device 516, and/or sensor 520 in some examples. Additionally or alternatively, the coil 510 may be part of (e.g., form an antenna for) the wireless interface 518 in some examples. Further, while the components of FIG. 5 are shown as being integrated into a single housing, in other examples the components can be distributed from (e.g., in separate housings) and electrically coupled to each other.

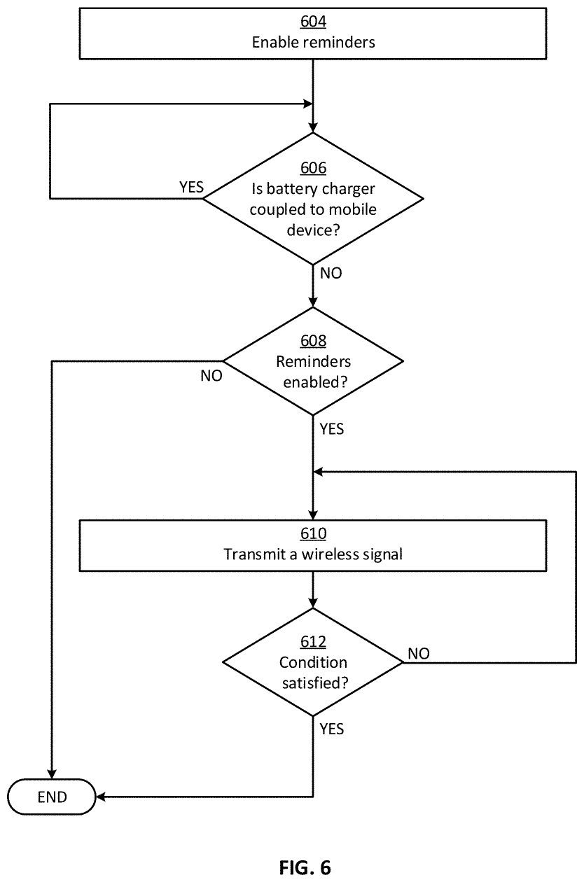

FIG. 6 shows an example of a flow chart of steps for implementing a battery-charger reminder system. Other examples can include more steps, fewer steps, different steps, or a different combination of the steps shown in FIG. 6. The steps below are discussed with reference to the components discussed above with respect to FIG. 5.

In block 604, a battery charger 500 enables reminders as there may be times when reminders are not needed (e.g., if the charger is not needed for a period of time). In some examples, enabling reminders can involve updating a memory location. For example, the battery charger 500 can set a flag in RAM to turn on reminder functionality. In other examples, enabling reminders can involve establishing an electrical coupling between two or more electrical components of the battery charger 500. For example, the battery charger 500 can close a switch or bias a transistor to turn on reminder functionality.

In some examples, the battery charger 500 enables reminders in response to a wireless communication from the mobile device. For example, the mobile device can execute a software application associated with the battery-charger reminder system in which the user can turn on or off reminders. If the user turns on reminders, the mobile device can transmit a wireless communication configured to cause the battery charger 500 to enable reminders. The battery charger 500 can receive the wireless communication via the wireless interface 518 and responsively enable reminders.

In some examples, the battery charger 500 enables reminders in response to a sensor signal from a sensor 520. For example, the sensor 520 can include a user input device, such as a button or switch for turning on or off reminders. The battery charger 500 can detect that the button or switch is in an “on” position, and responsively enable reminders.

In block 606, the battery charger 500 determines whether it is coupled to the mobile device. This may involve determining whether the battery charger 500 is mechanically coupled to the mobile device, electrically coupled to the mobile device, or both.

In some examples, the battery charger 500 determines whether it is coupled to the mobile device based on a sensor signal from the sensor 520. For example, the sensor 520 can be a current sensor configured to detect current in a cable 508 for charging the mobile device. The battery charger 500 can use the current sensor to detect whether or not there is current flowing through the cable 508. If so, the battery charger 500 can determine that the mobile device is electrically coupled to the battery charger 500. If not, the battery charger 500 can determine that the mobile device is not electrically coupled to the battery charger 500. As another example, the sensor 520 can be a sensor configured to detect an electromagnetic coupling between the battery charger 500 and the mobile device during wireless charging. The battery charger 500 can use the sensor 520 to detect whether or not the electromagnetic coupling is present. If so, the battery charger 500 can determine that the mobile device is electrically coupled to the battery charger 500. If not, the battery charger 500 can determine that the mobile device is not electrically coupled to the battery charger 500.

If the battery charger 500 determines that it is coupled to the mobile device, the process can return to block 606 and repeat (e.g., one or more times). If the battery charger 500 determines that it is not coupled to the mobile device, the process can continue to block 608.

In block 608, the battery charger 500 determines if reminders are enabled. For example, the battery charger 500 can access a memory location to determine whether it has a certain value or flag indicating that reminders are enabled. If the battery charger 500 determines that reminders are disabled, the process can end. If the battery charger 500 determines that reminders are enabled, the process can continue to block 610.

In block 610, the battery charger 500 transmits a wireless signal via the wireless interface 518. The battery charger 500 can transmit the wireless signal to the mobile device.

In block 612, the battery charger 500 determines if one or more conditions are satisfied. If not, the process can return to block 610 and repeat. Otherwise, the process can end.

One example of a condition can include a wireless-transmission limit. For example, the battery charger 500 can be configured to only send a certain number of wireless transmissions, such as 5 transmissions. This may help reduce power consumption by the battery charger 500 and prevent unnecessary wireless transmissions (e.g., if the mobile device does not receive the first 5 transmissions, it may indicate that the mobile device is out of range of the battery charger 500 and subsequent transmissions would be unsuccessful). Each time the battery charger 500 transmits a wireless signal in block 610, the battery charger 500 can increment a counter. With each iteration, the battery charger 500 can compare the counter's value to the wireless-transmission limit to determine whether the limit has been reached.

Another example of a condition can include receiving a wireless response from the mobile device. For example, if the mobile device receives the wireless signal transmitted in block 610, it may provide a wireless response to the battery charger 500 in order to confirm receipt of the wireless signal. The battery charger 500 can detect the wireless response via the wireless interface 518 and, based on the wireless response, determine that the condition is satisfied. This may help prevent the battery charger 500 from sending unnecessary wireless transmissions, for example, after the mobile device 500 has already triggered a reminder.

Another example of a condition can include receiving a wireless communication from the mobile device indicating that reminders are to be turned off. For example, the mobile device can execute a software application through which the user can turn on or off reminders. If the user turns the reminders off, the mobile device can transmit a wireless communication configured to cause the battery charger 500 to turn off reminders. The battery charger 500 can receive the wireless communication and, in response, disable reminders and determine that the condition is satisfied.

Another example of a condition can include detecting a sensor signal from the sensor 520 indicating that reminders are to be turned off. For example, the sensor 520 can include a button or switch for turning on or off reminders. The battery charger 500 can detect that the button or switch is in an “off” position associated with turning off reminders and, in response, disable reminders and determine that the condition is satisfied.

Another example of a condition can include the expiration of a time period. For example, the battery charger 500 can be configured to only transmit wireless signals for the time period, such as 10 minutes. So, the battery charger 500 can initiate a timer (e.g., upon detecting that the battery charger is no longer coupled to the mobile device) and determine that the condition is satisfied when the time period has expired. This may help prevent the battery charger 500 from endlessly transmitting wireless signals and consuming electrical power.

In some examples, at least a portion of the above process may be repeated each time the mobile device is coupled to the battery charger 500. For example, the battery charger 500 can detect that the mobile device is positioned on a wireless charging-pad and responsively initiate the process, starting at block 606. As another example, the battery charger 500 can detect that the mobile device is coupled to the battery charger 500 via a cable 508, and responsively initiate the process, starting at block 606.

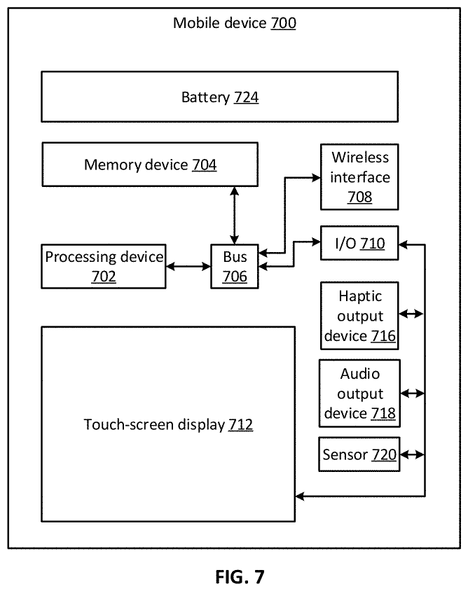

FIG. 7 shows a block diagram of an example of a mobile device 700. In this example, the mobile device 700 includes a processing device 702, a memory device 704 communicatively coupled to the processing device 702 via a bus 706, and a wireless interface 708. These components may be similar to the processing device 514, memory device 516, and wireless interface 518, respectively, described with respect to FIG. 5.

The mobile device 700 also includes I/O components 710. The I/O components 710 can facilitate connection to various input devices and output devices, such one or more displays, touch-screen displays 712, touch pads, keyboards, mice, audio output devices 718 (e.g., speaker), microphones, haptic output devices 716 (e.g., eccentric rotating mass motors), sensors 720, buttons, switches, and/or other hardware used to input data or output data.

Sensor 720 can represent one or more sensors. The sensor 720 can transmit sensor signals to the processing device 702. Examples of sensor 720 can include a voltage sensor, current sensor, force sensor, Hall Effect sensor, contact sensor, gyroscope, GPS unit, ultrasonic transducer, coil, accelerometer, range sensor, depth sensor, camera, temperature sensor, radio frequency identification (RFID) unit, or any combination of these.

The mobile device 700 further includes a battery 724, such as a lithium ion battery. The battery 724 can be recharged using a battery charger, such as the battery charger 500 shown in FIG. 5.

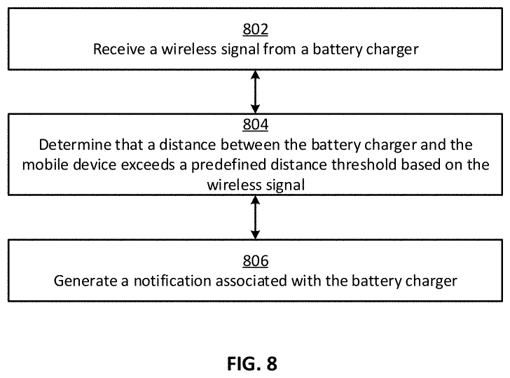

In some examples, the mobile device 700 can perform the steps in FIG. 8 to implement a battery-charger reminder system. Other examples can include more steps, fewer steps, different steps, or a different combination of the steps shown in FIG. 8. The steps below are discussed with reference to the components discussed above with respect to FIG. 7.

In block 802, the mobile device 700 receives a wireless signal from a battery charger (e.g., via wireless interface 708). The wireless signal can be, for example, a Bluetooth signal received via a Bluetooth interface, or a radio signal received via a radio interface.

In some examples, the wireless signal includes location data indicating a location of the battery charger. Examples of the location data can include the geographical coordinates (e.g., latitude and longitude coordinates) of the battery charger, a relative location of the battery charger to the mobile device, a relative distance between the battery charger and the mobile device, or any combination of these.

In block 804, the mobile device 700 determines that a distance between the battery charger and the mobile device exceeds a predefined distance threshold. The mobile device 700 can make this determination based on one or more characteristics (e.g., the amplitude, duration, waveform, frequency, or content) of the wireless signal, as detected by the mobile device 700.

For example, the wireless signal can include location data representative of the battery charger's GPS location. The battery charger may have previously determined its GPS location (using a GPS unit) and incorporated the location data into the wireless signal. The mobile device 700 can receive the wireless signal and determine the GPS location of the battery charger based on the location data included in the wireless signal. The mobile device 700 can also determine its own GPS location using its own GPS unit. The mobile device 700 can then compare the battery charger's GPS location to its own GPS location to determine a distance between the two. After determining the distance between the two, the mobile device 700 can determine whether the distance exceeds the predefined distance threshold.

In some examples, the mobile device 700 can determine that the distance between the battery charger and the mobile device 700 exceeds the predefined distance threshold based on a signal strength (e.g., amplitude) of the wireless signal transmitted by the battery charger. For example, the signal strength of the wireless signal may be related (e.g., inversely proportional) to the distance between the battery charger and the mobile device 700. So, the mobile device 700 can compare the signal strength of the wireless signal to a signal-strength threshold, which in turn can be associated with the predefined distance threshold. If the signal strength of the wireless signal is below the signal-strength threshold, the mobile device 700 can determine that the distance exceeds the predefined distance threshold. And vice-versa.

In block 806, the mobile device 700 generates (e.g., outputs and/or triggers) a notification associated with the battery charger. The mobile device 700 can generate the notification in response to determining that the distance exceeds the predefined distance threshold. The notification can include an auditory notification, a visual notification, a haptic notification, or any combination of these. The notification can be an alert configured to remind a user about the battery charger.

While FIG. 8 illustrates an implementation in which the notification is generated based on a wireless signal from the battery charger, other examples may involve a notification being generated in response to one or more other events. For example, the mobile device 700 can wirelessly transmit a request to the battery charger and wait for a response for a predefined time period, such as 5 seconds (s). If the mobile device 700 does not receive a response within the predefined time period, it may indicate that the battery charger is out of range of the mobile device 700 (e.g., that the battery charger did not receive the wireless request). This, in turn, may indicate that the distance between the mobile device 700 and the battery charger exceeds the predefined distance threshold. So, the mobile device 700 can generate the notification.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. And examples disclosed herein can be combined and rearranged to yield additional examples.

1. A battery charger for a mobile device, the battery charger comprising:
a wireless interface configured to transmit a wireless signal usable by the mobile device to determine a proximity of the battery charger to the mobile device.

2. The battery charger of claim 1, further comprising:
an attachment device configured to electrically couple the battery charger to a power source for receiving an electrical signal;
a coupling device configured to electrically couple the battery charger to the mobile device for charging a battery of the mobile device; and
electrical circuitry that is electrically coupled between the attachment device and the coupling device, the electrical circuitry being configured to convert the electrical signal from the power source into a modified version of the electrical signal;
wherein the wireless interface is electrically coupled to the electrical circuitry for receiving the modified version of the electrical signal.

3. The battery charger of claim 2, wherein:
the electrical circuitry comprises a step-down transformer configured to transform the electrical signal into the modified version of the electrical signal, the modified version of the electrical signal having a lower voltage than the electrical signal; and
the wireless interface is configured to operate using the lower voltage provided by the modified version of the electrical signal.

4. The battery charger of claim 1, further comprising a sensor, wherein the battery charger is configured to:
detect that the battery charger is not coupled to the mobile device based on a sensor signal from the sensor; and
cause the wireless interface to transmit the wireless signal in response to detecting that the battery charger is not coupled to the mobile device.

5. The battery charger of claim 1, wherein the battery charger is configured to create an electromagnetic coupling with the mobile device for wirelessly charging a battery of the mobile device.

6. The battery charger of claim 1, further comprising a global positioning system (GPS) unit configured to identify a GPS location of the battery charger, wherein the wireless signal indicates the GPS location of the battery charger.

7. A mobile device comprising:
a battery;
a wireless interface configured to transmit and receive wireless signals;
a processing device; and
a memory device including program code that is executable by the processing device for causing the processing device to:
receive a wireless signal from a battery charger via the wireless interface;
determine that a distance between the battery charger and the mobile device exceeds a predefined distance threshold based on the wireless signal; and
in response to determining that the distance exceeds the predefined distance threshold, generate a notification associated with the battery charger.

8. The mobile device of claim 7, wherein:
the wireless signal indicates a first global positioning system (GPS) location of the battery charger;
the mobile device further comprises a GPS unit for determining a second GPS location of the mobile device; and
the memory device further includes program code that is executable by the processing device for causing the processing device to:
determine the distance between the battery charger and the mobile device by comparing the first GPS location of the battery charger to the second GPS location of the mobile device.

9. The mobile device of claim 7, wherein the memory device further includes program code that is executable by the processing device for causing the processing device to:
determine a signal strength of the wireless signal; and
determine that the distance between the battery charger and the mobile device exceeds the predefined distance threshold based on the signal strength of the wireless signal being below a signal-strength threshold.

10. The mobile device of claim 9, wherein the wireless signal is a Bluetooth signal and the wireless interface comprises a Bluetooth interface.

11. The mobile device of claim 7, wherein the mobile device includes a mobile phone, a tablet, an e-reader, or a laptop computer.

12. The mobile device of claim 7, wherein the notification comprises at least one of: (i) a visual notification configured to be output by a display, (ii) an auditory notification configured to be output by an audio output device, or (iii) a haptic notification configured to be output by a haptic output device.

13. The mobile device of claim 7, wherein the notification is configured to remind a user about the battery charger.

14. The mobile device of claim 7, wherein the memory device further includes program code that is executable by the processing device for causing the processing device to:
use the wireless interface to wirelessly transmit a request signal;
wait for a response to the request signal from the battery charger for a predefined time period;
determine that the response to the request signal was not received from the battery charger within the predefined time period; and
in response to determining that the response was not received from the battery charger within the predefined time period, generate the notification associated with the battery charger.

15. The mobile device of claim 7, wherein:
the mobile device is part of a system that includes the battery charger;
the wireless interface is a first wireless-interface; and
the battery charger comprises:
an attachment device configured to couple the battery charger to a power source for receiving an electrical signal;
a coupling device configured to couple the battery charger to the mobile device for charging the battery of the mobile device;
electrical circuitry that is coupled between the attachment device and the coupling device, the electrical circuitry being configured to convert the electrical signal from the power source into a modified version of the electrical signal; and
a second wireless-interface coupled to the electrical circuitry for receiving the modified version of the electrical signal, the wireless interface being configured to transmit the wireless signal to the mobile device.

16. A method comprising:
receiving, via a wireless interface of a mobile device, a wireless signal from a battery charger, wherein the battery charger is separate from the mobile device and operable to charge a battery of the mobile device;
determining, by the mobile device, that a distance between the battery charger and the mobile device exceeds a predefined distance threshold based on the wireless signal; and
in response to determining that the distance exceeds the predefined distance threshold, generating, by the mobile device, a notification associated with the battery charger.

17. The method of claim 16, wherein the wireless signal indicates a first global positioning system (GPS) location of the battery charger, and further comprising:
determining a second GPS location of the mobile device using a GPS unit coupled to the mobile device; and
determining the distance between the battery charger and the mobile device by comparing the first GPS location of the battery charger to the second GPS location.

18. The method of claim 16, further comprising:
determining a signal strength of the wireless signal; and
determining that the distance between the battery charger and the mobile device exceeds the predefined distance threshold based on the signal strength of the wireless signal being below a signal-strength threshold.

19. The method of claim 16, wherein the mobile device is remote from the battery charger and includes a mobile phone, a tablet, an e-reader, or a laptop computer.

20. The method of claim 16, further comprising transmitting, by the battery charger, the wireless signal to the mobile device.
